(19) United States
(12) Patent Application Publication
(10) Pub. No.: US 2015/0003469 A1
(43) Pub. Date: Jan. 1, 2015

(54) Method for optimal allocation of resources in a multi-user network

(71) Applicant: Feliciano Gomez Martinez, San Jose, CA (US)

(72) Inventor: Feliciano Gomez Martinez, San Jose, CA (US)

(73) Assignee: LANTIQ DEUTSCHLAND GMBH, Neubiberg (DE)

(21) Appl. No.: 14/122,269

(22) PCT Filed: May 25, 2012
(86) PCT No.: PCT/US12/39489

§ 371 Date: Sep. 17, 2014

Related U.S. Application Data
(60) Provisional application No. 61/490,058, filed on May 26, 2011.

(51) Int. Cl. H04J 3/02; H04L 25/02

(52) U.S. Cl. CPC H04J 3/02; H04L 25/024
USPC 370/442

(57) ABSTRACT

The present disclosure relates generally to communication systems and more particularly to wired communication systems. One embodiment relates to a network arrangement, comprising at least one master node and plurality of slave nodes coupled to the master node. The master node and slave nodes communicate over a medium (e.g., telephone wiring, coaxial cables, or power lines) with time-variant channel characteristics. The master node includes a processing block to receive inputs from the plurality of slave nodes. The inputs used by the processing block to generate an optimized Time-Division Multiple Access (TDMA) schedule which is broadcast to the plurality of slave nodes. Other methods and systems are also disclosed.

### RELATED APPLICATIONS

The present application claims priority to U.S. provisional application having Ser. No. U.S. 61/490,058, entitled “METHOD FOR OPTIMAL ALLOCATION OF RESOURCES IN A MULTI-USER NETWORK” and filed on May 26, 2011. This provisional application is incorporated by reference into this application in its entirety.

### FIELD OF DISCLOSURE

The present invention relates generally to Telecommunication systems and more particularly to wired networking systems utilizing telephone wiring, coaxial cables, or power lines as physical media.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

One embodiment relates to a network arrangement, comprising at least one master node and plurality of slave nodes coupled to the master node. The master node and slave nodes communicate over a medium (e.g., telephone wiring, coaxial cables, or power lines) with time-variant channel characteristics. The master node includes a processing block to receive inputs from the plurality of slave nodes. The inputs are used by the processing block to generate an optimized Time-Division Multiple Access (TDMA) schedule which is broadcast to the plurality of slave nodes. Other methods and systems are also disclosed.

The following description and annexed drawings set forth in detail certain illustrative aspects and implementations of the invention. These are indicative of only a few of the various ways in which the principles of the invention may be employed.

### BRIEF DESCRIPTION OF THE DRAWINGS

FIG. 1a illustrates some embodiments of a communication network comprising three nodes.

FIG. 1b illustrates some embodiments of six unidirectional links formed in a communication network comprising three nodes.

FIG. 2 illustrates some embodiments of a relationship between a link capacity and an available signal-to-noise ratio.

FIG. 3 illustrates a flow diagram for some embodiments of a nave left-to-right allocation method for solving the scheduling problem.

FIG. 4 illustrates a flow diagram for some embodiments of an optimized left-to-right allocation method for solving the scheduling problem.

FIG. 5 illustrates a flow diagram for some embodiments of βᵢⱼ maximization method for solving the scheduling problem.

FIG. 6 illustrates a flow diagram for some embodiments of βᵢⱼ maximization method with next step estimation for solving the scheduling problem.

FIG. 7 illustrates some embodiments of a schematic of a G.hn network arrangement.

FIG. 8 illustrates some embodiments of a schematic of multiple G.hn network arrangements with a shared physical medium.

### DETAILED DESCRIPTION

One or more implementations of the present invention are now described with reference to the attached drawings, wherein like reference numerals are used to refer to like elements throughout, and wherein the various structures are not necessarily drawn to scale. In the following description, for purposes of explanation, numerous specific details are set forth in order to facilitate understanding. It may be evident, however, to one of ordinary skill in the art, that one or more aspects described herein may be practiced with a lesser degree of these specific details. In other instances, known structures and devices are shown in block diagram form to facilitate understanding.

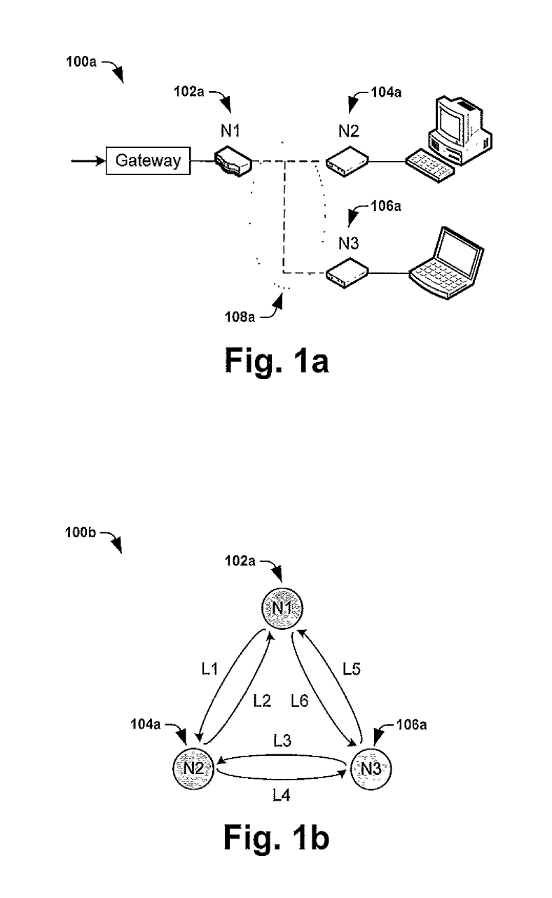

FIG. 1a illustrates some embodiments of a communication network 100a comprising three nodes: a network access node 102a, a first network communication node 104a, and a second network communication node 106a, which are coupled through a shared physical medium 108a. For bidirectional communication between three nodes the shared physical medium 108a must support at least six unidirectional links, as illustrated in FIG. 1b (L1-L6). In general, the number of unidirectional links L required in a network comprising N nodes is given by L=N(N−1). As the number of nodes in a network is increased, the number of unidirectional links grows exponentially.

Many multi-user communication systems operate over physical media with time-variant channel characteristics. One example of this is powerline communications systems that operate over AC wiring, which are subject to noise generated by devices coupled to the AC wiring. This noise can sometimes be predicted if it is generated by a process that is synchronized with an AC cycle of the wiring. In such systems, know as synchronous channel or SyncCh, the noise parameters will vary with a frequency that is an integer multiple of a basic 50 Hz or 60 Hz AC cycle, or MAC cycle.

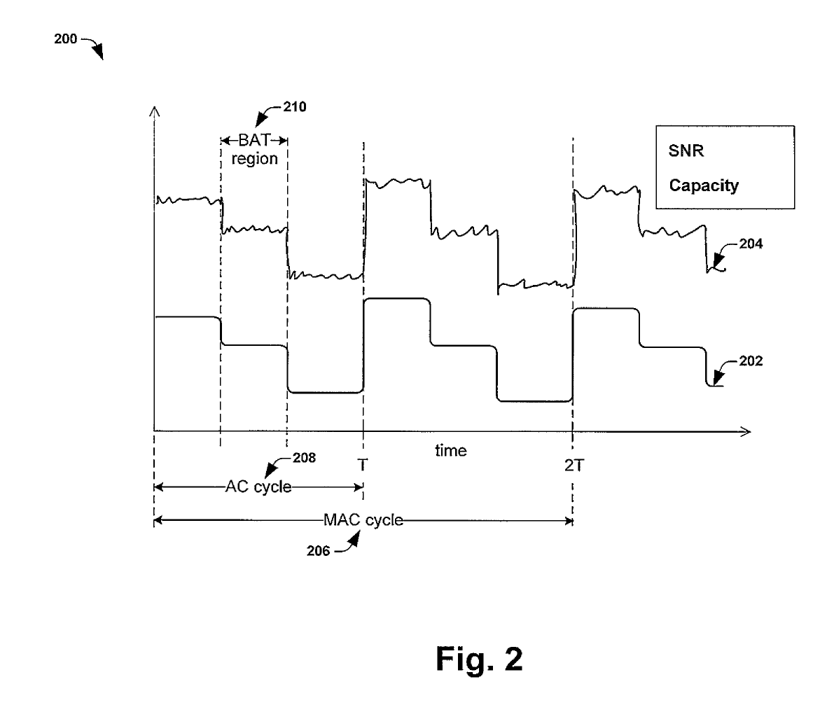

FIG. 2 illustrates some embodiments of a relationship 200 between a line data rate 202 and an available signal-to-noise ratio (SNR) 204 in a communication systems designed to achieve data transfer rates close to Shannon's limit (the maximum error-free data rate of the system). The line data rate 202 is adaptive and dependent on the available SNR 204, such that higher SNR ratio 204 implies higher line data rate 202. In order to optimize the system capacity, the line data rate 202 will need to change periodically, closely tracking the changes in the SNR 204. In SyncCh systems the SNR 204 will change with time in a periodic manner on an MAC cycle 206 (shown as a 2× multiple of the AC cycle 208). Regions where the SNR 204 (and associated line data rate 202) remain relatively constant are defined as Bit Allocation Table (BAT) regions 210 in the G.hn standard.

Multi-user communication systems must insure that only one device is using a physical medium at a given time to avoid data collisions. One way to achieve this is to define a Time-Division Multiple Access (TDMA) schedule that all of the nodes in a network must follow. Choosing an optimal schedule can be a non-trivial problem for networks comprising a large number of nodes, and may be further complicated by requiring that a certain node or set of nodes meet a minimum network capacity, or Quality of Service (QoS).

Accordingly, the present disclosure relates to a method and network arrangement in a communication system that can achieve an optimal (or near optimal) capacity allocation for multiple links with time-varying capacities. A TDMA schedule is formulated in terms of matrices and vectors that describe various input parameters of the network arrangement. A number of algorithms are then provided which can define the TDMA schedule in various ways. Optimal algorithms are provided which use linear programming techniques to find a TDMA schedule that is optimal for one or more parameters of the network arrangement. Heuristic algorithms are also provided. These algorithms may be solved and implemented in hardware though the use of a central node that broadcasts a TDMA schedule that all of the other nodes in a network must follow.

A TDMA schedule may be formulated for a network comprising L unidirectional links, with a MAC cycle T that is divided into K BAT regions. The duration of each BAT region j is tⱼ, where jε[1, . . . K]. The capacity available for link i during time t₁ is βᵢⱼ, where iε[1, . . . L]. The fraction of region tⱼ allocated to link i, or time-slot, is given by αᵢⱼ such that αᵢⱼ≧0. If a required capacity for link i is assumed as δᵢ, then a total capacity of all time-slots allocated to link i is γᵢ, which may be computed in as follows:

$${γ}_{i} = \frac{1}{T} {\sum }_{j ∈ [ 1 , … K ]} {α}_{ij} {β}_{ij} {t}_{j} \geq {δ}_{i}$$

A restriction that no more than 100% of the fraction of region tⱼ allocated to link i (with i in 1, . . . L) results in the additional restriction that Σ_{iε[1, . . . L]} αᵢⱼ≦1. This problem may be formulated in vector form as the following:

### Given:

$$β = ( \begin{matrix}{β}_{11} & {β}_{12} & … & {β}_{1 K} \\ {β}_{21} & {β}_{22} & … & {β}_{2 K} \\ ⋮ & ⋮ & ⋱ & ⋮ \\ {β}_{L 1} & {β}_{L 2} & … & {β}_{LK}\end{matrix} )$$

$$t = ( \begin{matrix}{t}_{1} \\ {t}_{2} \\ ⋮ \\ {t}_{K}\end{matrix} )$$

$$δ = ( \begin{matrix}{δ}_{1} \\ {δ}_{2} \\ ⋮ \\ {δ}_{L}\end{matrix} )$$

Find a schedule matrix:

$$α = ( \begin{matrix}{α}_{11} & {α}_{12} & … & {α}_{1 K} \\ {α}_{21} & {α}_{22} & … & {α}_{2 K} \\ ⋮ & ⋮ & ⋱ & ⋮ \\ {α}_{L 1} & {α}_{L 2} & … & {α}_{LK}\end{matrix} )$$

such that an allocation condition is met:

$$γ = \frac{1}{T} ( α ∘ β ) \cdot t \geq δ$$

and subject to constraints α≧0 and I_{L}^{T}·α≦I_{K}^{T}. Here α o β represents the element-by-element product of α and β, and I_{L} represents an L-dimensional all-ones column vector.

In principle there may be an infinite number of unique allocations a that satisfy the allocation condition. The allocation condition may be optimized for one or more parameters of the network. To maximize the aggregate network capacity (the total network throughput), one may maximize Σᵢ₌₁^{L} γᵢ with no further constraints. To maximize the aggregate network capacity with the constraint that all links achieve equal capacity, maximize Σᵢ₌₁^{L} γᵢ with the requirement that (γ₁=γ₂= . . . =γ_{L}). To maximize the amount of unallocated time slots while guaranteeing that γ≧δ, minimize Σᵢ₌₁^{L} Σⱼ₌₁^{K} αᵢⱼtⱼ with the following constraints:

$$γ = \frac{1}{T} ( α ∘ β ) .$$

t≧δ (provides L inequalities), α≧0 (provides L×K inequalities), and Σ_{iε[1, . . . L]} αᵢⱼ≦1 (provides K inequalities). The aforementioned maximizations comprise Optimal Algorithms that may be solved using Linear Programming.

Linear Programming is a set techniques that are well-known to one of skill in the art that may be employed to solve a standard minimization problem:

### Find:

y=[y₁,y₂, . . . ,yₘ]^{T}

that minimizes:

y^{T}b=y₁b₁+y₂b₂+ . . . +yₘbₘ

subject to the constraints y^{T}A≧c, and y≧0. If an optimal scheduling problem can be represented as a standard minimization problem, then Linear Programming methods may be used.

To express an optimal scheduling problem as a standard minimization problem for arbitrary values of L and K, define an auxiliary variable:

$${ω}_{ij} = \frac{1}{T} {β}_{ij} {t}_{j}$$

Then, matrices A, b, and c are given by:

$$\begin{matrix}A = ( \begin{matrix}{ω}_{11} & 0 & … & 0 & - 1 & 0 & … & 0 \\ {ω}_{12} & 0 & … & 0 & 0 & - 1 & … & 0 \\ ⋮ & ⋮ & ⋱ & ⋱ & ⋮ & ⋮ & ⋱ & ⋮ \\ {ω}_{1 K} & 0 & … & 0 & 0 & 0 & … & - 1 \\ 0 & {ω}_{21} & … & 0 & - 1 & 0 & … & 0 \\ 0 & {ω}_{21} & … & 0 & 0 & - 1 & … & 0 \\ ⋮ & ⋮ & ⋱ & ⋱ & ⋮ & ⋮ & ⋱ & ⋮ \\ 0 & {ω}_{2 K} & … & 0 & 0 & 0 & … & - 1 \\ 0 & 0 & … & 0 & - 1 & 0 & … & 0 \\ 0 & 0 & … & 0 & 0 & - 1 & … & 0 \\ ⋮ & ⋮ & ⋱ & ⋱ & ⋮ & ⋮ & ⋱ & ⋮ \\ 0 & 0 & … & 0 & 0 & 0 & … & - 1 \\ 0 & 0 & … & {ω}_{L 1} & - 1 & 0 & … & 0 \\ 0 & 0 & … & {ω}_{L 2} & 0 & - 1 & … & 0 \\ ⋮ & ⋮ & ⋱ & ⋮ & ⋮ & ⋮ & ⋱ & ⋮ \\ 0 & 0 & … & {ω}_{LK} & 0 & 0 & … & - 1\end{matrix} ) & \\ b = ( \begin{matrix}{t}_{1} \\ {t}_{2} \\ ⋮ \\ {t}_{K} \\ {t}_{1} \\ {t}_{2} \\ ⋮ \\ {t}_{K} \\ {t}_{1} \\ {t}_{2} \\ ⋮ \\ {t}_{K} \\ {t}_{1} \\ {t}_{2} \\ ⋮ \\ {t}_{K}\end{matrix} ) & \\ c = ( \begin{matrix}{δ}_{1} \\ {δ}_{2} \\ ⋮ \\ {δ}_{L} \\ - 1 \\ - 1 \\ ⋮ \\ - 1\end{matrix} ) & \end{matrix}$$

The relationship between a and y is given by:

$$\begin{matrix}α = ( \begin{matrix}{α}_{11} & {α}_{12} & … & {α}_{1 K} \\ {α}_{21} & {α}_{22} & … & {α}_{2 K} \\ ⋮ & ⋮ & ⋱ & ⋮ \\ {α}_{L 1} & {α}_{L 2} & … & {α}_{LK}\end{matrix} ) \\ = ( \begin{matrix}{y}_{1} & {y}_{2} & … & {y}_{K} \\ {y}_{K + 1} & {y}_{K + 2} & … & {y}_{2 K} \\ ⋮ & ⋮ & ⋱ & ⋮ \\ {y}_{( L - 1 ) K + 1} & {y}_{( L - 1 ) K + 2} & … & {y}_{LK}\end{matrix} )\end{matrix}$$

such that the an allocation condition

$$γ = \frac{1}{T} ( α ∘ β ) \cdot t \geq δ$$

may be represented as a standard minimization problem, to minimize y^{T}b subject to y^{T}A≧c and y≧0.

The simplex method or the interior point method are examples of Optimal Algorithms that utilize Linear Programming techniques to solve the optimal scheduling problem when represented as a standard minimization problem. Heuristic Algorithms may also provide a solution to the scheduling problem, though these are not guaranteed to be optimal.

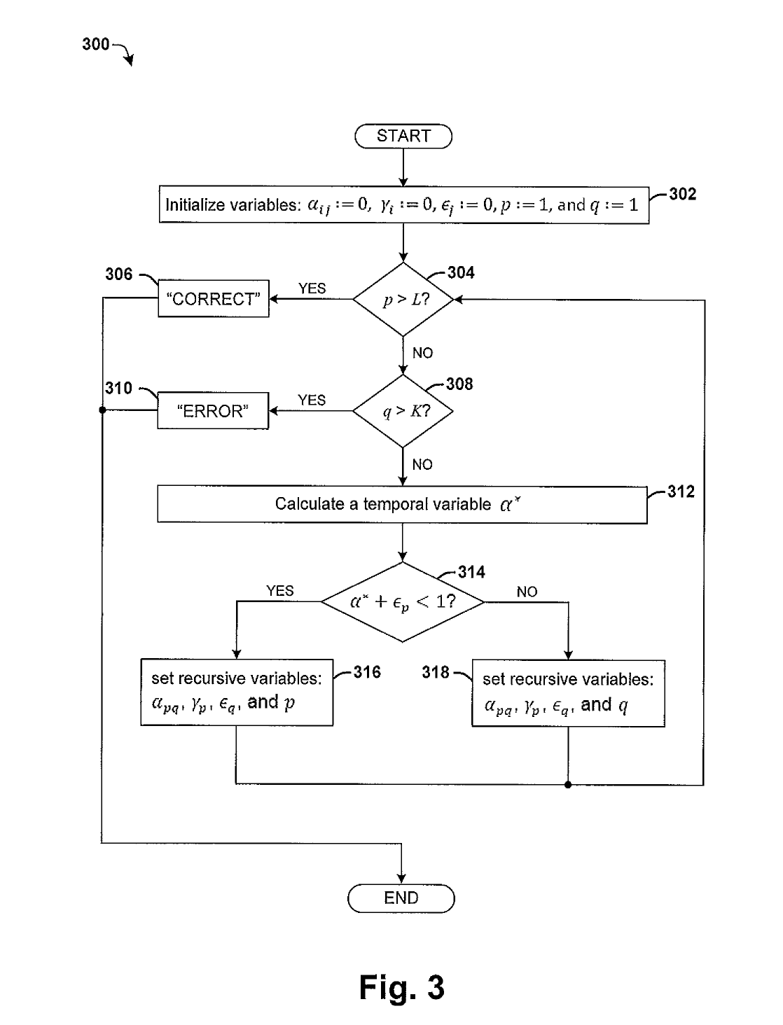

FIG. 3-FIG. 6 describe various Heuristic methods for solving the scheduling problem. While these methods are illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

FIG. 3 illustrates a flow diagram for some embodiments of a nave left-to-right allocation method 300 for solving the scheduling problem. While presented as a baseline, the nave left-to-right allocation method 300 is not recommended for use in practice, because it does not really search for an optimal solution, although it may sometimes find a feasible solution. The method 300 basically consists of allocating “time-slots” sequentially from “left-to-right” to link i=1 until γ₁≧δ₁, then to link i=2 until γ₂≧δ₂, and so on for all iε[1, . . . L].

At step 302 initialize recursive variables: αᵢⱼ:=0 (fraction of region j allocated to link i=algorithm output), γᵢ:=0 (Total capacity of all time slots allocated to link i=Σⱼ αᵢⱼβᵢⱼtⱼ), εⱼ:=0 (the fraction of the capacity allocated to region j=Σⱼαᵢⱼ), p:=1 (the lowest link with γᵢ<δᵢ), and q:=1 (the time region with εⱼ<1).

At step 304 a first exit condition is checked. If p>L, then the algorithm has found a feasible schedule.

At step 306, if the first exit condition is met (YES at 304), then return “CORRECT” and exit the algorithm.

At step 308 a first error condition is checked. If q>K, then the algorithm has not found a feasible schedule.

At step 310, if the first error condition is met (YES at 308), then return “ERROR” and exit the algorithm.

At step 312 calculate a temporal variable

$${α}^{*} = \frac{T ( {δ}_{p} - {γ}_{p} )}{{β}_{pq} {t}_{q}} .$$

At step 314 determine if fractional capacity has been exceeded. α*+εₚ<1?

At step 316, if the fractional capacity has not been exceeded (YES at 314), then set recursive variables: α_{pq}:=α*,

$${γ}_{p} := {γ}_{p} + \frac{{α}_{pq} {β}_{pq} {t}_{q}}{T} = {δ}_{p} ,$$

ε_{q}:=ε_{q}+α_{pq}, and p:=p+1; and return to step 304.

At step 318, if the fractional capacity has been exceeded (NO at 314), then set recursive variables: α_{pq}:=1−ε_{q},

$${γ}_{p} := {γ}_{p} + \frac{{α}_{pq} {β}_{pq} {t}_{q}}{T} ,$$

ε_{q}:=ε_{q}+α_{pq}=1, and q:=q+1; and return to step 304.

The nave left-to-right allocation method 300 completes (with “CORRECT” or “ERROR” results) in no more than L+K+1 steps, wherein each step calculates a new value of a*, plus one extra step for either step 316 or step 318. If the nave left-to-right allocation method 300 returns “ERROR,” then it has not been able to satisfy all of the constraints. In particular, it has not been able to insure that all γᵢ≧δᵢ.

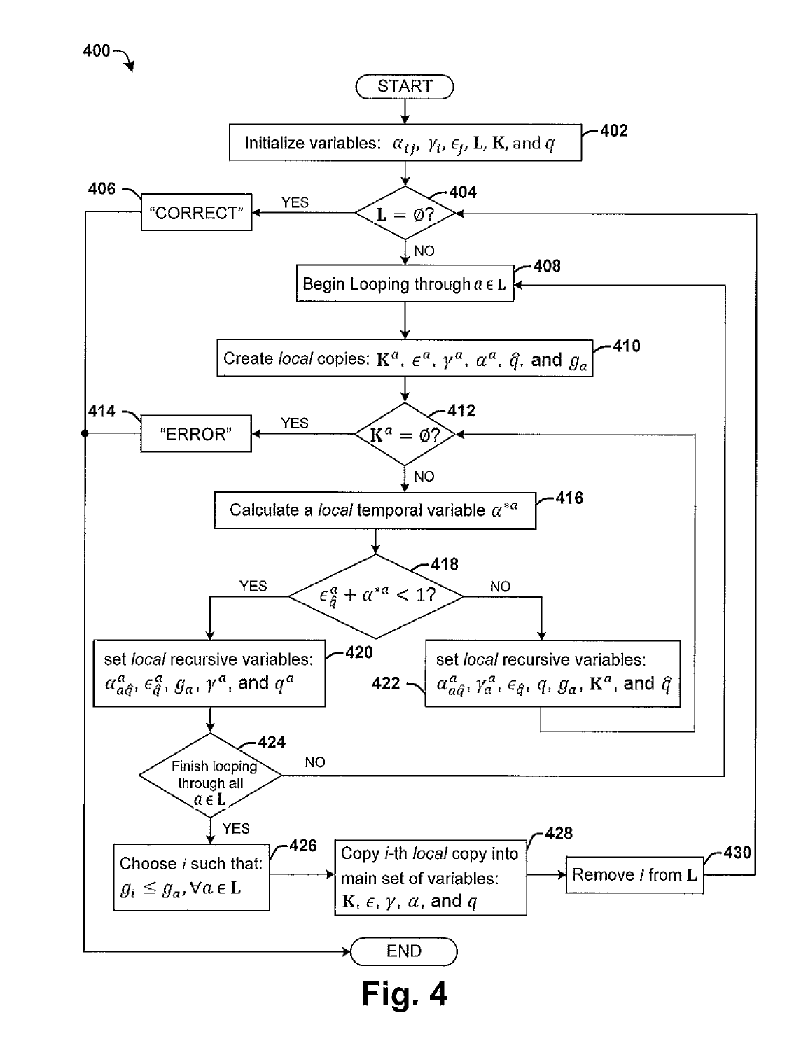

FIG. 4 illustrates a flow diagram for some embodiments of an optimized left-to-right allocation method 400 for solving the scheduling problem. The optimized left-to-right allocation method 400 is an optimized version of the nave left-to-right allocation method 300. The method 400 essentially starts by allocating a time-slot to link i that requires the shortest time-slot. In other words, calculate α*ᵢ for each i and choose the smallest one. This process is repeated sequentially for all iε[1, . . . L] in order of increasing α*ᵢ size. Calculating the length of each candidate time slot is an iterative process, so local copies of all parameters must be maintained.

At step 402 initialize recursive variables: αᵢⱼ:=0 (algorithm output and intermediate allocation steps), γᵢ:=0 (the capacity allocated to link i, equal to εⱼ αᵢⱼβᵢⱼtⱼ), εⱼ:=0 (the fraction of the capacity allocated to region j, equal to εⱼ αᵢⱼ), L:=(1, 2, . . . L) (the set of all links for which γᵢ<δᵢ), K:=(1, 2, . . . K) (the set of regions for which εⱼ<1), and q:=1 (the lowest time region with εⱼ<1).

At step 404 a first exit condition is checked. If L=φ, then the algorithm has found a feasible schedule.

At step 406, if the first exit condition is met (YES at 404), then return “CORRECT” and exit the algorithm.

At step 408, if the first exit condition is not met (NO at 404), begin looping through a E L.

At step 410 create local copies of all recursive variables: K^{a}:=K, ε^{a}:=ε, γ^{a}:=γ, α^{a}:=α, \hat{q}:=q, and gₐ:=0 for each aεL.

At step 412 a first error condition is checked. If K^{a}=φ, then the algorithm has not found a feasible schedule.

At step 414, if the first error condition is met (YES at 410), then return “ERROR” and exit the algorithm.

At step 416, if the first error condition is not met (NO at 410), calculate a local temporal variable

$${α}^{* a} := \frac{T ( {δ}_{a} - {γ}_{a}^{a} )}{{β}_{a \hat{q}} {t}_{\hat{q}}} .$$

At step 418 determine if local fractional capacity has been exceeded. ε_{\hat{q}}^{a}+α*^{a}<1?

At step 420, if the local fractional capacity has not been exceeded (YES at 418), then set recursive variables: α_{a\hat{q}}^{a}:=α*^{a}, ε_{\hat{q}}^{a}:=ε_{\hat{q}}^{a}+α_{a\hat{q}}^{a}, gₐ:=gₐ+α_{a\hat{q}}^{a} t_{\hat{q}}, γ^{a}:=δₐ, and q^{a}:=\hat{q}.

At step 422, if the fractional capacity has been exceeded (NO at 416), then set recursive variables: α_{a\hat{q}}^{a}:=1−ε_{\hat{q}},

$${γ}_{a}^{a} := {γ}_{a}^{a} + \frac{{α}_{a \hat{q}}^{a} {β}_{a \hat{q}} {t}_{\hat{q}}}{T} ,$$

ε_{\hat{q}}:=1, q:=q+1, gₐ:=gₐ+α_{a\hat{q}}^{a} t_{\hat{q}}, K^{a}:=K^{a}−{\hat{q}}, \hat{q}:=\hat{q}+1; and return to step 410.

At step 424, determine whether to continue looping through aεL (i.e., do any aεL remain that have not been looped through?).

At step 426 choose i such that gᵢ≦gₐ, ∀aεL.

At step 428 copy the i-th copy local copy into the main set of variables: K:=Kⁱ, ε:=εⁱ, γ:=γⁱ, α:=αⁱ, and q:=q^{a}.

At step 430 remove i from L: L:=L−{i}; and return to step 404.

The optimized left-to-right allocation method 400 completes (with “CORRECT” or “ERROR” results). Calculating an upper-bound on the number of iterations for the optimized left-to-right allocation method 400 is non-trivial, but can loosely be estimated as (L·K)·(K+1)K/2 steps.

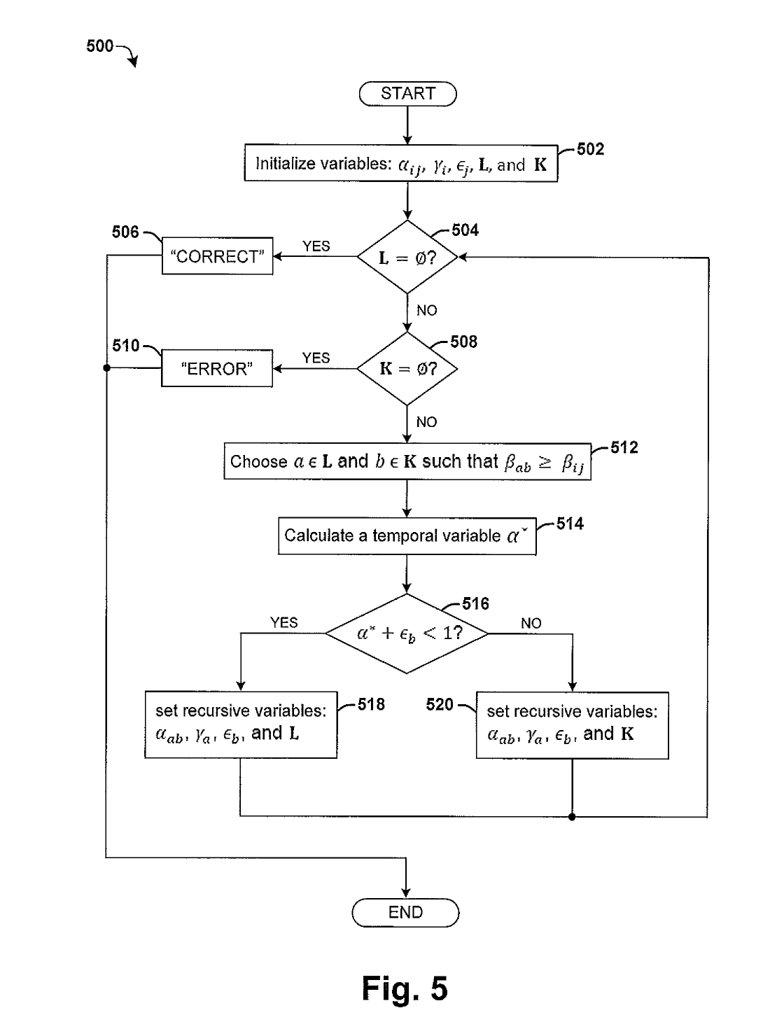

FIG. 5 illustrates a flow diagram for some embodiments of βᵢⱼ maximization method 500 for solving the scheduling problem. The method 500 basically consists of choosing the highest value of βᵢⱼ, and allocating a time slot (as large as needed) to link i in region j. When link i achieves γᵢ≧δᵢ, remove it from consideration. When a region has been fully allocated (εⱼ=1), remove it from consideration. Repeat the process until all links achieve γᵢ≧δᵢ or until εⱼ=1.

At step 502 initialize recursive variables: αᵢⱼ:=0 (algorithm output and intermediate allocation steps), γᵢ:=0 (the capacity allocated to link i, equal to Σⱼ αᵢⱼβᵢⱼtⱼ), εⱼ:=0 (the fraction of the capacity allocated to region j, equal to Σⱼ αᵢⱼ), L:=(1, 2, . . . L), and K:=(1, 2, . . . K).

At step 504 a first exit condition is checked. If L=φ, then the algorithm has found a feasible schedule.

At step 506, if the first exit condition is met (YES at 504), then return “CORRECT” and exit the algorithm.

At step 508 a first error condition is checked. If K=φ, then the algorithm has not found a feasible schedule.

At step 510, if the first error condition is met (YES at 508), then return “ERROR” and exit the algorithm.

At step 512 choose aεL and bεK such that β_{ab}≧βᵢⱼ ∀iεL and ∀iεK (the maximum value of βᵢⱼ).

At step 514 calculate a temporal variable

$${α}^{*} := \frac{T ( {δ}_{a} - {γ}_{a} )}{{β}_{ab} {t}_{b}} .$$

At step 516 determine if fractional capacity has been exceeded. α*+ε_{b}<1?

At step 518, if the fractional capacity has not been exceeded (YES at 516), then set recursive variables: α_{ab}:=α*,

$${γ}_{a} := {γ}_{a} + \frac{{α}_{ab} {β}_{ab} {t}_{b}}{T} = {δ}_{a} ,$$

ε_{b}:=ε_{b}+α_{ab}, and L:=L−{a}; and return to step 504.

At step 520, if the fractional capacity has been exceeded (NO at 516), then set recursive variables: α_{ab}:=1−ε_{b},

$${γ}_{a} := {γ}_{a} + \frac{{α}_{ab} {β}_{ab} {t}_{b}}{T} ,$$

ε_{b}:=ε_{b}+α_{ab}=1, and K:=K−{b}; and return to step 504.

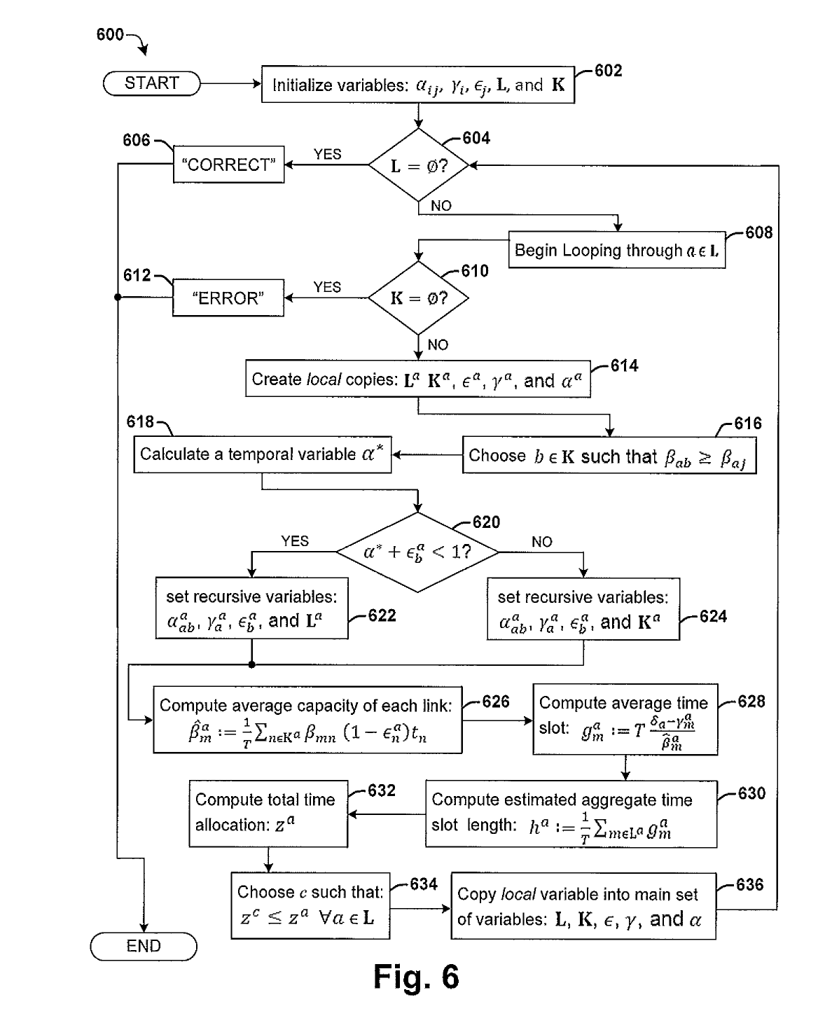

The βᵢⱼ maximization method 500 may not always find a feasible solution, even if one exists. One way to enhance the method 500 is to direct the algorithm to look beyond allocating a time slot to see if a solution is still feasible after the allocation. FIG. 6 illustrates a flow diagram for some embodiments of βᵢⱼ maximization method with next step estimation 600 for solving the scheduling problem.

At step 602 initialize recursive variables: αᵢⱼ:=0 (algorithm output and intermediate allocation steps), γᵢ:=0 (the capacity allocated to link i, equal to εⱼ αᵢⱼβᵢⱼtⱼ), εⱼ:=0 (the fraction of the capacity allocated to region j, equal to Σⱼ αᵢⱼ), L:=(1, 2, . . . L), and K:=(1, 2, . . . K).

At step 604 a first exit condition is checked. If L=φ, then the algorithm has found a feasible schedule.

At step 606, if the first exit condition is met (YES at 604), then return “CORRECT” and exit the algorithm.

At step 608, if the first exit condition is not met (NO at 604), begin looping through a E L.

At step 610 a first error condition is checked. If K=φ, then the algorithm has not found a feasible schedule.

At step 612, if the first error condition is met (YES at 608), then return “ERROR” and exit the algorithm.

At step 614 create local copies of all recursive variables: L^{a}:=L K^{a}:=K, ε^{a}:=ε, γ^{a}:=γ, and α^{a}:=α for each aεL.

At step 616 choose b E K such that β_{ab}≧βₐⱼ ∀jεK (the maximum value of βₐⱼ).

At step 618 calculate a temporal variable

$${α}^{*} := \frac{T ( {δ}_{a} - {γ}_{a} )}{{β}_{ab} {t}_{b}} .$$

At step 620 determine if fractional capacity has been exceeded. α*+ε_{b}^{a}<1?

At step 622, if the fractional capacity has not been exceeded (YES at 618), then set recursive variables: α_{ab}^{a}:=α*,

$${γ}_{a}^{a} := {γ}_{a}^{a} + \frac{{α}_{ab}^{a} {β}_{ab} {t}_{b}}{T} = {δ}_{a} ,$$

ε_{b}^{a}:=ε_{b}^{a}+α_{ab}^{a}, and L^{a}:=L^{a}−{b}.

At step 624, if the fractional capacity has been exceeded (NO at 516), then set recursive variables: α_{ab}^{a}:=1−ε_{b}^{a},

$${γ}_{a}^{a} := {γ}_{a}^{a} + \frac{{α}_{ab}^{a} {β}_{ab} {t}_{b}}{T} ,$$

ε_{b}^{a}:=ε_{b}^{a}+α_{ab}^{a}=1, and K^{a}:=K^{a}−{b}.

At step 626, compute the average capacity of each link m εL^{a}:

$${\hat{β}}_{m}^{a} := \frac{1}{T} {\sum }_{n ∈ {K}^{a}} {β}_{mn} ( 1 - {∈}_{n}^{a} ) {t}_{n} ∀ m ∈ {L}^{a} .$$

At step 628, compute the average time-slot required to achieve capacity constraint in each link mεL^{a}:

$${g}_{m}^{a} := T \frac{{δ}_{a} - {γ}_{m}^{a}}{{\hat{β}}_{m}^{a}} ∀ m ∈ {L}^{a} .$$

At step 630, compute the estimated aggregate time-slot length for all

$$m ∈ {L}^{a} : {h}^{a} := \frac{1}{T} {\sum }_{m ∈ {L}^{a}} {g}_{m}^{a} = {\sum }_{m ∈ {L}^{a}} \frac{{T}^{2} ( {δ}_{a} - {γ}_{m}^{a} )}{{\sum }_{n ∈ {K}^{a}} {β}_{mn} ( 1 - {∈}_{n}^{a} ) {t}_{n}} .$$

At step 632, compute total time allocation: z^{a}:=α_{ab}^{a}t_{b}+h^{a}.

At step 634, choose c such that z^{c}≦z^{a} ∀aεL.

At step 636, copy the local variables to main variables: L:=L^{c}, K:=K^{c}, ε:=ε^{c}, γ:=γ^{c}, and α:=α^{c}; and return to step 604.

The embodiments of methods 300-600 assume that the when a time-slot of duration αᵢⱼtⱼ is allocated to link i, the complete time-slot is used to transmit data. In reality, all multiple-access communications systems require nodes to transmit some overhead signal (e.g., preambles, headers, acknowledgements, etc.), or leave the channel idle for some time (e.g., inter-frame gaps, etc.). For the embodiments of methods 300-600, the overhead can be modeled with a modification of some parameters. For transmission of p bits of data in a channel with a capacity β, a time required is defined as:

$${t}_{t} = η + {t}_{p} = η + \frac{p}{β}$$

where tₜ is the total time, tₚ is the transmission time (dependent upon p), and is the overhead time (not dependent upon p).

Therefore, an equation for calculating αᵢⱼ for link i in region j will be given by:

$${t}_{t} = {α}_{ij} {t}_{j} = η + \frac{( {δ}_{i} - {γ}_{i} ) T}{{β}_{ij}}$$

$${α}_{ij} = \frac{1}{{t}_{j}} ( η + \frac{( {δ}_{i} - {γ}_{i} ) T}{{β}_{ij}} )$$

where each region has a minimum size (tⱼ≧η). Additionally, a minimum allocation size for any αᵢⱼ can never be less than

$$\frac{η}{{t}_{j}} .$$

This modification for an accurate area overhead estimation may be applied to the embodiments of methods 300-600

These families of Optimal Algorithms and Heuristic Algorithms provide different trade-offs in terms of computational complexity and solution performance. An implementation can choose between these two classes of algorithms depending upon environmental constraints. For example: if computational resources are limited, or a solution has to be found in a limited amount of time, an implementation may choose a fast algorithm to find a feasible albeit non-optimal solution.

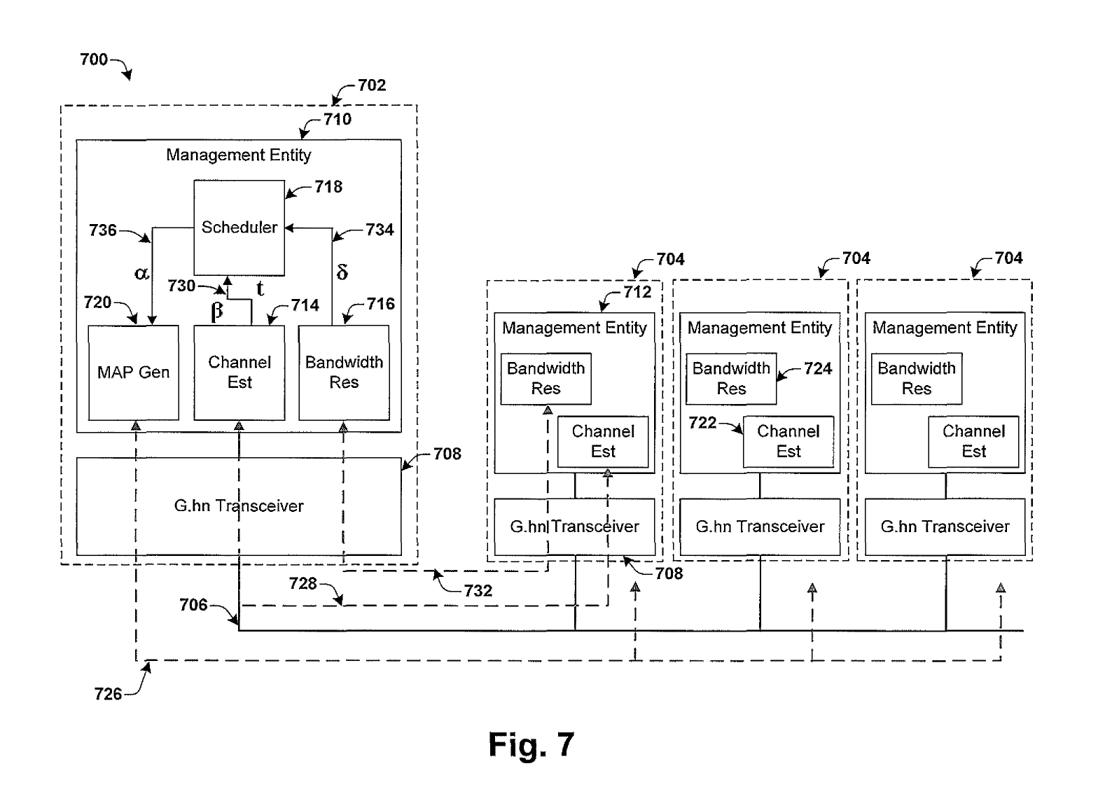

FIG. 7 illustrates some embodiments of a schematic of a G.hn network arrangement 700, comprising a single master node 702 and a plurality of slave nodes 704 which communicate over a wired medium 706 (e.g., power lines, coaxial cables, or twisted pairs). Each node from the set comprising the master node 702 and slave nodes 704 comprises a G.hn transceiver 708. The master node 702 comprises a first management entity 710, and a respective slave node from the plurality of slave nodes 704 comprises a second management entity 712. The first management entity 710 comprises a first channel estimation block 714 (e.g., as defined in G.hn), a first bandwidth reservation block 716, a scheduler block 718, and a MAP generation block 720. The second management entity comprises a second channel estimation block 722 and a second bandwidth reservation block 724.

The MAP generation block 720 is configured to build a MAP message 726 and broadcast it to the plurality of slave nodes 704. The MAP message 726 comprises information about the length of a MAC cycle (T) and a schedule of time-slots allocated to one or more nodes from the set comprising the master node 702 and slave nodes 704.

Each pair of channel estimation blocks formed from a set comprising the first channel estimation block 714 and respective second channel estimation blocks 722 are configured to communicate a first protocol 728 that results in a bit-loading table for communication between each pair of nodes formed from a set comprising the master node 702 and the plurality of slave nodes 704. Bit loading tables may be different for different parts of the MAP cycle. Whenever a pair of nodes updates the a bit-loading table, they inform the master node 702 by sending an updated first protocol 728 that includes which regions of the MAC cycle are impacted by the update.

Additionally, the first channel estimation 714 block is configured to communicate a second protocol 730 to the scheduler block 718, comprising a vector t comprising K elements corresponding to the length of K time regions within the MAC cycle, and a matrix β comprising L×K elements corresponding to a bit rate for L links between the set of N nodes within K time regions.

A respective second bandwidth reservation block 724 is configured to communicate a third protocol 732 to the first bandwidth reservation block 716, wherein the third protocol 732 comprises a request for a predetermined amount of bandwidth for a connection formed between a pair of nodes from a set of N nodes comprising the at least one master node and the plurality of slave nodes. The third protocol 732 also includes an option for the first bandwidth reservation block 716 to accept or reject the request.

Additionally, the first bandwidth reservation block 716 is configured to periodically communicate a vector δ 734 to the scheduler block 718, wherein the vector δ 734 comprises L elements corresponding to a requested bandwidth for each of the L links between each pair of nodes from the set of N nodes.

The scheduler block 718 takes the inputs t, β, and δ and uses an algorithm from families of Optimal Algorithms and Heuristic Algorithms previously described to calculate an optimal schedule α 736 comprising an L×K matrix in which each element αᵢⱼ represents an amount of channel time allocated to link i during time region j. The optimal schedule α 736 is sent to the MAP generation block 720.

The MAP generation block 720 receives the optimal schedule α 736 from the scheduler block 718 and builds the MAP message 726 that implements a time-slot allocation as described by the optimal schedule α 736 matrix. The MAP message 726 is then broadcast to the plurality of slave nodes 704, which will then follow the time-slot allocation.

The families of Optimal Algorithms and Heuristic Algorithms previously described may also be used in scenarios where multiple G.hn networks share the same physical medium. In general, a cooperation may be achieved either through centralized methods which rely on a single device (e.g., a “Global Master” that is responsible for scheduling time-slots for each domain), or distributed methods which different networks negotiate with each other.

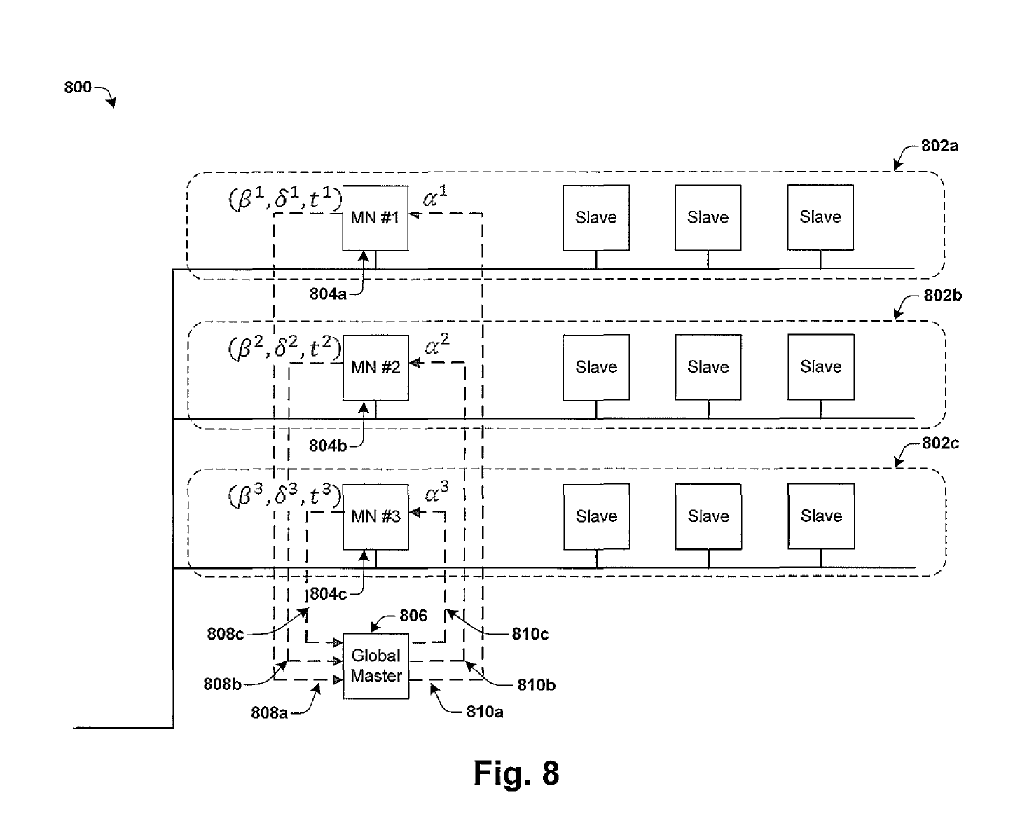

FIG. 8 illustrates some embodiments of a schematic of multiple G.hn network arrangements 800 with a shared physical medium, comprising a 1^{st} domain (e.g., network) 802a, a 2^{nd} domain 802b, and a 3^{rd} domain 802c, with full node-to-node visibility (i.e., all three domains “see” each other over the shared physical medium). The 1^{st} domain 802a comprises a first master node 804a, the 2^{nd} domain 802b comprises a second master node 804b, and the 3^{rd} domain 802c comprises a third master node 804c. The 1^{st} domain 802a, the 2^{nd} domain, and the 3^{rd} domain 802c all use a same MAC cycle T (as mandated in the G.hn standard). For N G.hn network arrangements with full visibility, a superindex n (where n=1 . . . N) may be associated with the parameters of the n^{th} domain. For the embodiments of 800 N=3. A master node of the n^{th} domain sends a global master 806 values for tⁿ, βⁿ, and δⁿ over one of a plurality of first communication channels, comprising 808a-808c. The global master 806 may comprise the first master node 804a, the second master node 802b, or the third master node 802c, or it may be an independent device.

After receiving tⁿ, βⁿ, and δⁿ from each domain, the global master 806 computes values for t^{g}, β^{g}, and δ^{g} (g is an index for the global master 806). δ^{g} is a vector of L^{g} elements, where

$${L}^{g} = {\sum }_{n = 1}^{N} {L}^{n}$$

t^{g} is a vector with K^{g} elements, and β^{g} is a L^{g}×K^{g} matrix, where K^{g} is the minimum number of time regions that insure that βᵢⱼ^{g} is a constant. If BAT regions in different domains are exactly aligned with each other, then a best case value of K^{g} is given by:

K^{g}=Kⁿ

but if the BAT regions in different domains are mis-aligned, then a worst case value of K^{g} is given by:

$${K}^{g} = 1 + {\sum }_{n = 1}^{N} ( {K}^{n} - 1 )$$

In practice, K^{g} will be somewhere between the best and worst case values, because some BAT regions are aligned while others are not.

After computing values for t^{g}, β^{g}, and δ^{g} the global master 806 computes an allocation matrix α^{g} using any of the algorithms from the families of Optimal Algorithms and Heuristic Algorithms previously described, and uses it to build domain-specific matrices αⁿ (where n=1 . . . N), wherein a respective matrix αⁿ is sent to the n^{th} master node (e.g., one of 804a-804c) of the n^{th} domain over one of a plurality of second communication channels, comprising 810a-810c. The n^{th} master node uses an to construct a MAP message to be broadcast to the n^{th} domain.

Thus, the above described embodiments are a method and network arrangement in a communication system that can achieve an optimal (or near optimal) capacity allocation for multiple links with time-varying capacities. Although the invention has been illustrated and described with respect to one or more implementations, alterations and/or modifications may be made to the illustrated examples without departing from the spirit and scope of the appended claims. For example, although certain embodiments of the invention have been described with respect to wired communication systems conforming to the G.hn standard, the invention is applicable to any wired communication system operating at full bandwidth capacity, or a wireless communication channel if channel conditions (signal-to-noise ratio) change in a periodic manner.

In addition, although various illustrated embodiments are illustrated as a hardware structure, the functionality and corresponding features of the present device can also be performed by appropriate software routines or a combination of hardware and software.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. An apparatus that generates a Media Access Plan (MAP) message to be used in a network having a number of nodes and links coupling the nodes, wherein at least one node is the master and one or more nodes are slaves, the apparatus comprising:
a channel estimation unit that generates:
a vector t of K time regions indicating a length of time of the time regions,
wherein the time regions correspond to regions of periodic noise having period T,
a matrix β of L×K elements indicating a bit-rate for at least one link in at least one time region;
a vector δ of L links indicating a target bandwidth for each link;
a scheduler unit that generates using t, β and δ an optimized schedule α, which is an L×K matrix in which elements αᵢⱼ represent an amount of channel time allocated to link i during time region j; and
a MAP generation unit that generates a MAP message including a schedule of time-slots allocated to one or more nodes in the network based on the optimized schedule α.

2. The apparatus of claim 1, wherein the MAP generation unit sends the MAP message over the network to one or more nodes.

3. The apparatus of claim 1, wherein the channel estimation unit in at least two nodes runs a protocol that exchanges messages with the same block in every other node. The protocol results in a bit-loading table for communication between each pair of nodes.

4. The apparatus of claim 1, wherein scheduler unit finds values of αᵢⱼ such that a total capacity allocated to link i (γᵢ) is equal to or greater than the target bandwidth for each link.

5. The apparatus of claim 4, wherein scheduler unit determines the optimized schedule α by minimizing an amount of time allocated to each link.

6. The apparatus of claim 5, wherein the scheduler unit minimizes the amount of time allocated to each link using at least one of the following selected from the group consisting of a simplex or an interior point apparatus.

7. The apparatus of claim 5, wherein the scheduler unit minimizes the amount of time allocated to each link by using a linear function.

8. The apparatus of claim 5, wherein the scheduler unit minimizes the amount of time allocated to each link by using a graphical solution.

9. The apparatus of claim 2, the scheduling unit calculates the optimized schedule α by finding an allocation that provides the maximum possible capacity allocated to link i (γᵢ).

10. The apparatus of claim 2, wherein the MAP generation unit sends the MAP message over a medium selected from the group consisting of power lines, coaxial cables, wireless and twisted pair wires.

11. The apparatus of claim 2, wherein the channel estimation unit determines the target bandwidth using a bit-loading table for communication between nodes.

12. The apparatus of claim 11, wherein the channel estimation unit generates the bit-loading table by exchanging messages between the nodes.
